(19) United States
(12) Patent Application Publication
(10) Pub. No.: US 2018/0365339 A1
(43) Pub. Date: Dec. 20, 2018

(54) APPLICATION CLASSIFICATION METHOD AND APPARATUS

(71) Applicant: ALIBABA GROUP HOLDING LIMITED, George Town (KY)

(72) Inventors: Guangyuan HUANG, Hangzhou (CN); Depin CHEN, Hangzhou (CN); Suyu LIU, Hangzhou (CN)

(21) Appl. No.: 16/116,812

(22) Filed: Aug. 29, 2018

Related U.S. Application Data
(63) Continuation of application No. PCT/CN2017/073867, filed on Feb. 17, 2017.

(30) Foreign Application Priority Data
Feb. 29, 2016 (CN) 201610113706.8

(51) Int. Cl. G06F 17/30; G06K 9/62; G06F 17/15

(52) U.S. Cl. CPC G06F 17/30958; G06F 17/15; G06K 9/628

(57) ABSTRACT

There is provided an application classification method and apparatus. The method includes: calculating a correlation coefficient between to-be-classified applications, wherein the to-be-classified applications are located in one or more known classification systems; constructing a node diagram for the to-be-classified applications based on the correlation coefficient; and dividing the node diagram to obtain one or more classification diagrams.

### CROSS-REFERENCE TO RELATED APPLICATION

The present application claims priority to International Application No. PCT/CN2017/073867, filed on Feb. 17, 2017, which claims priority to and the benefits of priority to Chinese Patent Application No. 201610113706.8 filed on Feb. 29, 2016, both of which are incorporated herein by reference in their entireties.

### TECHNICAL FIELD

The present disclosure relates to the field of computer processing technologies, and in particular, to an application classification method and an application classification apparatus.

### BACKGROUND

With the popularization of smart terminal devices, an increasing number of different applications are provided for use on the terminal devices. According to their needs, users can acquire applications from various application stores, such as Wandoujia and Huawei App Store.

At present, all applications in application stores are classified based on certain categories to facilitate downloading for users. However, different systems usually have different classification methods. For example, a classification system of Wandoujia is not exactly the same as a classification system of Huawei App Store. As a result, differences may exist in the total number of application categories, classification levels, and the like. Therefore, when various applications need to be managed, a single classification system may fail to meet the needs, and operation personnel still need to perform manual classification. As a result, the workload of classification operations is high, classification results are subjective, and there are risks such as inadequate consideration in classifying the applications.

### SUMMARY

In view of the foregoing problem, embodiments of the present disclosure are proposed to provide an application classification method and a corresponding application classification apparatus to overcome the foregoing problem or at least partially solve the foregoing problem.

In accordance to some embodiments of the present disclosure, there is provided an application classification method. The method includes determining a correlation coefficient between to-be-classified applications located in one or more known classification systems, constructing a node diagram for the to-be-classified applications based on the correlation coefficient, and dividing the node diagram to obtain one or more classification diagrams.

In accordance with some embodiments of the present disclosure, there is provided an application classification apparatus. The apparatus includes one or more memories configured to store executable program code and one or more processors. The one or more processors are configured to read the executable program code stored in the one or more memories to cause the application classification apparatus to perform a method. The method includes determining a correlation coefficient between to-be-classified applications located in one or more known classification systems, constructing a node diagram for the to-be-classified applications based on the correlation coefficient, and dividing the node diagram to obtain one or more classification diagrams.

In accordance with some embodiments of the present disclosure, there is provided a non-transitory computer-readable storage medium storing a set of instructions that is executable by one or more processors of an electronic device to cause the electronic device to perform a method. The method includes determining a correlation coefficient between to-be-classified applications located in one or more known classification systems, constructing a node diagram for the to-be-classified applications based on the correlation coefficient, and dividing the node diagram to obtain one or more classification diagrams.

Compared with the conventional art, the embodiments of the present disclosure have the following advantages. In the embodiments of the present disclosure, a correlation coefficient between to-be-classified applications is calculated. A node diagram is constructed based on the correlation coefficient, and then the node diagram is divided to obtain one or more classification diagrams. As such, reference is made to a plurality of currently known classification systems to integrate their practices, and no manual operation is required. Therefore, subjective classification results obtained from a manual operation or a risk that operation personnel fail to take adequate consideration in classifying the applications can be avoided. A new application classification system that may be more comprehensive can thus be provided.

In addition, in the embodiments of the present disclosure, after a new application classification system is obtained, the new classification diagram may be further assessed depending on an actual need, and a merging or further division operation may be performed to ensure accuracy of a final classification.

### BRIEF DESCRIPTION OF THE DRAWINGS

FIG. 1 is a flowchart of steps of first embodiments of an application classification method according to embodiments of the present disclosure;

FIG. 2 is a schematic diagram of application classification in an application store according to an existing technology;

FIG. 3A is a schematic diagram of a known classification system according to embodiments of the present disclosure;

FIG. 3B is a schematic diagram of another known classification system according to embodiments of the present disclosure;

FIG. 4 is a flowchart of steps of second embodiments of an application classification method according to embodiments of the present disclosure;

FIG. 5 is a schematic diagram of a node diagram according to embodiments of the present disclosure;

FIG. 6 is a schematic diagram of a classification diagram according to embodiments of the present disclosure; and

FIG. 7 is a structural block diagram of an application classification apparatus according to embodiments of the present disclosure.

### DETAILED DESCRIPTION

To make the foregoing objectives, features, and advantages of the present disclosure more comprehensible, the present disclosure is described in further detail in the following with reference to the accompanying drawings and specific implementation manners.

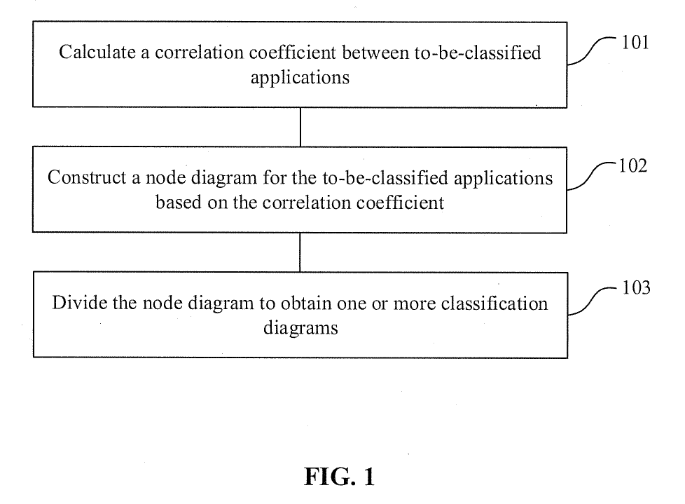

Referring to FIG. 1, a flowchart of steps of first embodiments of an application classification method according to the present disclosure is shown. The application classification method may specifically include the following steps.

In Step 101, a correlation coefficient between to-be-classified applications is calculated. In these embodiments of the present disclosure, when a new application classification system needs to be constructed, reference may be made to a plurality of currently known classification systems to integrate the practices of these systems to provide a new application classification system that may be more comprehensive. Thus, the workload of manual operations can be reduced. Namely, the to-be-classified applications may be applications located in one or more known classification systems.

Specifically, a correlation coefficient between to-be-classified applications can be calculated first. The correlation coefficient reflects correlation between any two applications. Generally, a larger correlation coefficient means that two applications are more correlated.

In some embodiments of the present disclosure, the step of calculating a correlation coefficient between to-be-classified applications may include the following substeps.

In Substep 1011, a shortest path between any two to-be-classified applications in the one or more known classification systems is separately determined.

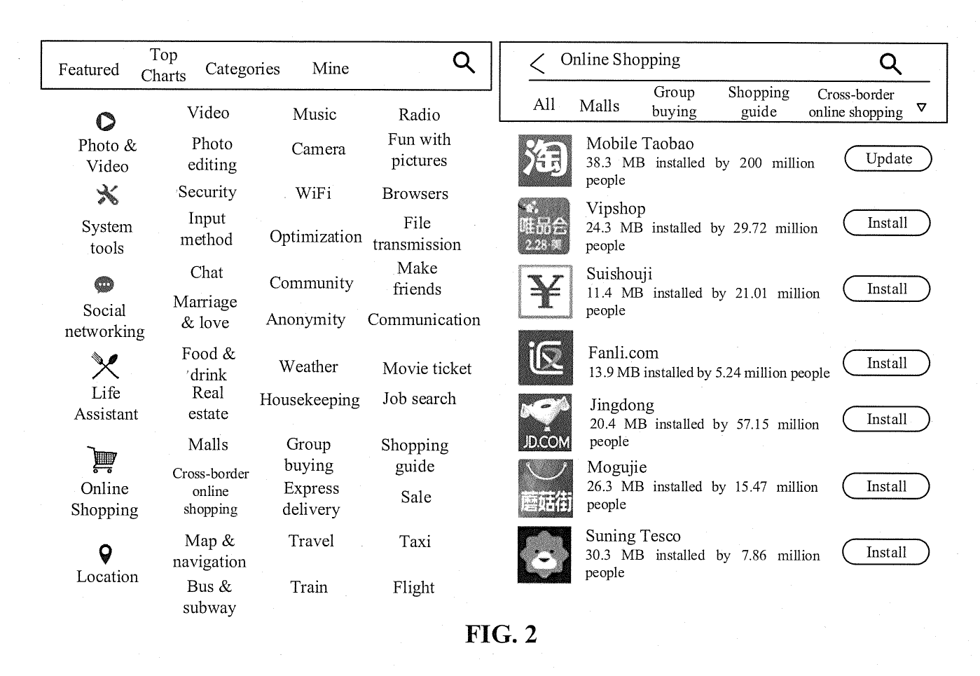

FIG. 2 is a schematic diagram of application classification in an application store according to an existing technology. Generally, applications may be classified into categories such as Photo & Video, System Tools, Social Networking, and the like. Each category may be further divided into different subcategories. For example, a category of Online Shopping may be divided into different subcategories such as Malls, Group buying, Shopping guide, and Cross-border online shopping. Each subcategory may include specific applications such as Mobile Taobao™, Fanli.com, and Suning Tesco. For ease of understanding, in embodiments of the present disclosure, a node diagram is used to represent a classification status in an application store, and nodes in the node diagram each represent a specific category or application.

Therefore, if applications are considered as nodes in a current classification system, a shortest path between any two to-be-classified applications in the classification system can indicate a distance between two nodes. Generally, a shorter distance between nodes means higher correlation.

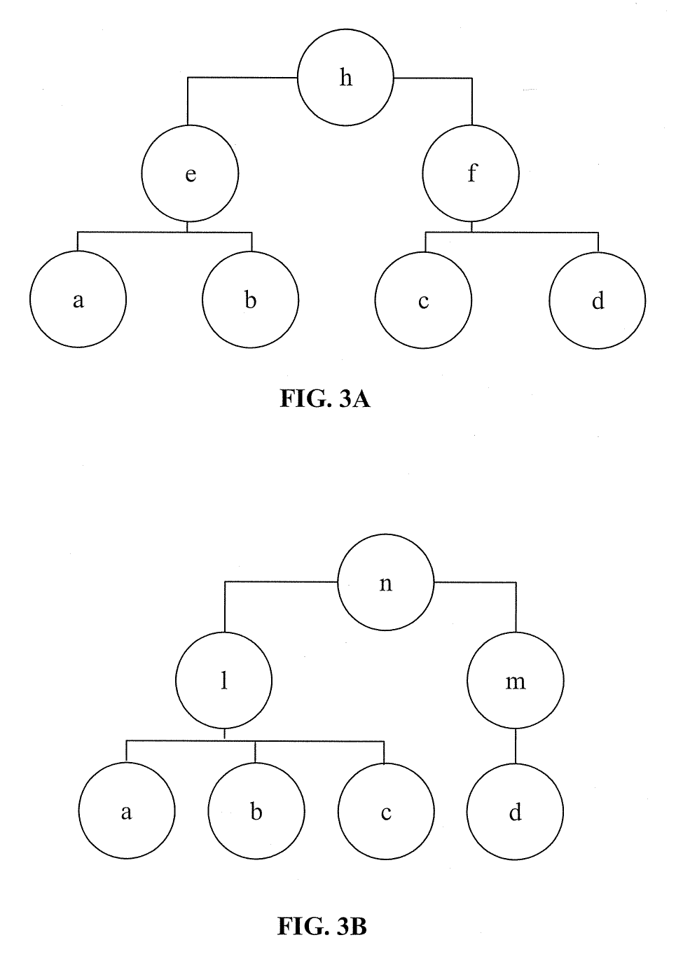

FIG. 3A and FIG. 3B are schematic diagrams of two different classification systems, wherein e, f, h, l, m, and n represent different categories, and a, b, c, and d are to-be-classified applications. For example, for applications a and b, a shortest path Shortest_path(a,b) between applications a and b in the classification system of FIG. 3A is 2, while a shortest path Shortest_path(a,b) between applications a and b in the classification system of FIG. 3B is also 2. For applications a and c, a shortest path Shortest_path(a,c) between applications a and c in the classification system of FIG. 3A is 4, while a shortest path Shortest_path(a,c) between applications a and c in the classification system of FIG. 3B is 2.

In a specific implementation, shortest paths between different nodes in classification systems may be obtained by using a Dijkstra algorithm.

In Substep 1012, a correlation coefficient between the any two to-be-classified applications is calculated by using the shortest path.

In a specific implementation, the correlation coefficient between the any two to-be-classified applications is calculated by using the following formula:

$$w ( a , b ) = \frac{1}{n} * {\sum }_{n = 1}^{n} ( \frac{2}{shortest\_path ( a , b )} )$$

wherein w(a,b) is a correlation coefficient between to-be-classified applications a and b; n is the number of known classification systems; and shortest_path(a,b) is a shortest path between the to-be-classified applications a and b in a known classification system.

Therefore, for applications a and bin the classification system of FIG. 3A and the classification system of FIG. 3B, it can be obtained by using the foregoing formula that a correlation coefficient between a and b is w(a,b)=1, and a correlation coefficient between a and c is w(a,c)=0.75.

Referring back to FIG. 1, in Step 102, a node diagram is constructed for the to-be-classified applications based on the correlation coefficient. In these embodiments of the present disclosure, after correlation coefficients between all to-be-classified applications are separately obtained, a node diagram may be constructed for the to-be-classified applications based on the correlation coefficients. In the node diagram, nodes represent different applications, and a connection line between nodes may represent a relationship between applications.

In a specific implementation, a correlation coefficient between the applications as obtained in step 101 can be used as a weight of an edge between the to-be-classified applications. A node diagram is constructed for the to-be-classified applications based on the weights of the edges. Generally, in the constructed node diagram, a larger weight between nodes means that the nodes are more correlated in a plurality of classification systems. For example, if two applications happen to belong to the same subcategory in a plurality of classification systems, a weight between the two applications may have a maximum value of 1.

In Step 103, the node diagram is divided to obtain one or more classification diagrams. In some embodiments of the present disclosure, the step of dividing the node diagram to obtain one or more classification diagrams may include the following substeps.

In Substep 1031, it is determined whether a weight of an edge in the node diagram is greater than a preset threshold.

In Substep 1032, the corresponding edge is retained if the weight of the edge is greater than the preset threshold, and the corresponding edge is deleted to obtain a new node diagram if the weight of the edge is not greater than the preset threshold.

In Substep 1033, the new node diagram is divided to obtain the one or more classification diagrams.

In a specific implementation, a weight threshold can first be set depending on an actual classification requirement, and then it is determined whether a weight of an edge in the node diagram is greater than the preset threshold. The corresponding edge is retained if the weight of the edge is greater than the preset threshold, and the corresponding edge is deleted to obtain a new node diagram if the weight of the edge is not greater than the preset threshold. For example, if the preset threshold is 0.5, all edges in a node diagram that have a weight value less than 0.5 may be first deleted to obtain a new node diagram. Then, the new node diagram is further divided to obtain one or more classification diagrams.

In the embodiments of the present disclosure, correlation coefficients between to-be-classified applications are calculated. A node diagram is constructed based on the correlation coefficients, and the node diagram is divided to obtain one or more classification diagrams. As such, reference is made to a plurality of currently known classification systems to integrate their practices, and no manual operation is required. Therefore, risks such as classification results obtained based on a subject determination in a manual operation or failures to take adequate consideration by operation personnel can be avoided. A new application classification system that may be more comprehensive can thus be provided.

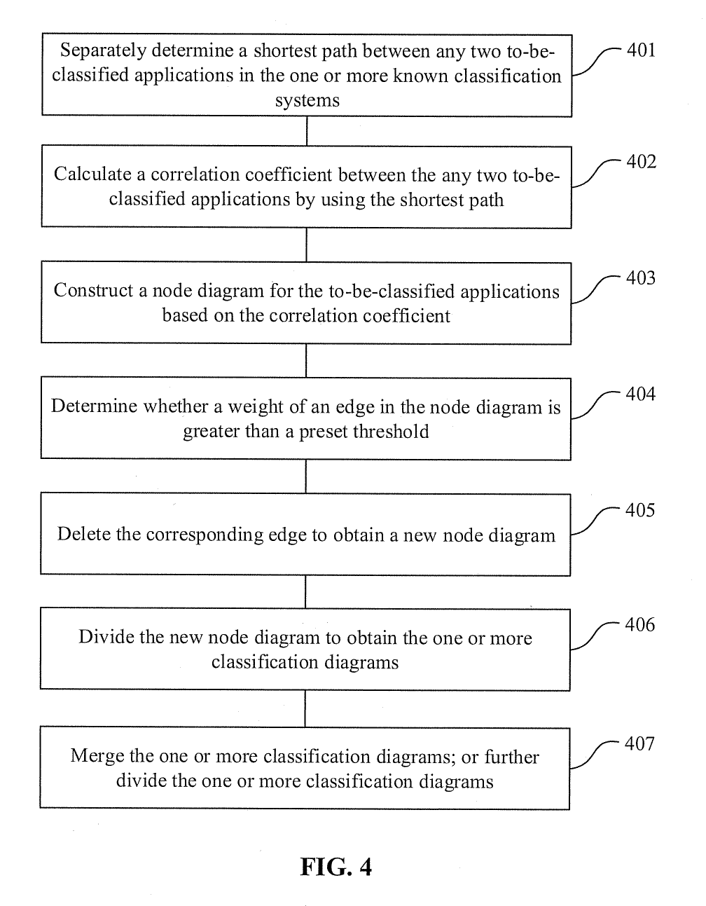

Referring to FIG. 4, a flowchart of steps of second embodiments of an application classification method according to the present disclosure is shown. The application classification method may include the following steps.

In Step 401, a shortest path between any two to-be-classified applications in the one or more known classification systems is separately determined. In these embodiments of the present disclosure, if applications are considered as nodes in a current classification system, a shortest path between any two to-be-classified applications in the classification system can indicate a distance between two nodes. Generally, a shorter distance between nodes means a higher correlation. Therefore, for to-be-classified applications, a shortest path between any two to-be-classified applications in the one or more known classification systems can be separately determined first.

FIG. 3A and FIG. 3B are schematic diagrams of two different classification systems, wherein e, f, h, l, m, and n represent different categories, and a, b, c, and d are to-be-classified applications. For example, for applications a and b, a shortest path Shortest_path(a,b) between applications a and b in the classification system of FIG. 3A is 2, while a shortest path Shortest_path(a,b) between applications a and b in the classification system of FIG. 3B is also 2. For applications a and c, a shortest path Shortest_path(a,c) between applications a and c in the classification system of FIG. 3A is 4, while a shortest path Shortest_path(a,c) between applications a and c in the classification system of FIG. 3B is 2.

In a specific implementation, shortest paths between different nodes in classification systems may be obtained by using a Dijkstra algorithm.

Referring back to FIG. 4, in Step 402, a correlation coefficient between the any two to-be-classified applications is calculated by using the shortest path. In a specific implementation, after the shortest path between the any two to-be-classified applications is separately determined, a correlation coefficient between the any two to-be-classified applications may be calculated based on the shortest path by using the following formula:

$$w ( a , b ) = \frac{1}{n} * {\sum }_{n = 1}^{n} ( \frac{2}{shortest\_path ( a , b )} )$$

wherein w(a,b) is a correlation coefficient between to-be-classified applications a and b; n is the number of known classification systems; and shortest_path(a,b) is a shortest path between to-be-classified applications a and b in a known classification system.

For example, for applications a and b in the classification system of FIG. 3A and the classification system of FIG. 3B, it can be obtained by using the foregoing formula that a correlation coefficient between a and b is w(a,b)=1, and a correlation coefficient between a and c is w(a,c)=0.75.

In Step 403, a node diagram is constructed for the to-be-classified applications based on the correlation coefficient. In some embodiments of the present disclosure, the step of constructing a node diagram for the to-be-classified applications based on the correlation coefficient may specifically include the following substeps

In Substep 4031, the correlation coefficient is used as a weight of an edge between the to-be-classified applications.

In Substep 4032, the node diagram is constructed for the to-be-classified applications based on the weight of the edge.

In a specific implementation, after a correlation coefficient between every two to-be-classified applications is obtained, the correlation coefficient may be used as a weight of an edge for constructing a node diagram. That is, any two applications are connected to obtain an edge, thus constructing a node diagram. The correlation coefficient between the applications is used as a weight value of the corresponding edge. Generally, in the constructed node diagram, a larger weight between nodes means that the nodes are more correlated in a plurality of classification systems. For example, if two applications happen to belong to the same subcategory in a plurality of classification systems, a weight between the two applications may have a maximum value of 1.

In Step 404, it is determined whether a weight of an edge in the node diagram is greater than a preset threshold. In a specific implementation, a weight threshold may first be set depending on an actual classification requirement. Then, it is determined whether a weight of an edge in the node diagram is greater than the preset threshold. The corresponding edge is retained if a weight of the edge is greater than the preset threshold, and Step 405 may be performed to delete the corresponding edge to obtain a new node diagram if the weight of the edge is not greater than the preset threshold. For example, if the preset threshold is 0.5, all edges in a node diagram that have a weight value less than 0.5 may be first deleted to obtain a new node diagram.

In Step 405, the corresponding edge is deleted to obtain a new node diagram.

In Step 406, the new node diagram is divided to obtain the one or more classification diagrams. In a specific implementation, the new node diagram may be divided by means of a community division algorithm FastUnfolding.

In some embodiments of the present disclosure, the step of dividing the new node diagram to obtain the one or more classification diagrams may include the following substeps.

In Substep 4061, a label is assigned to each to-be-classified application in the new node diagram.

In a specific implementation, for ease of calculation, the label may be a user ID of the to-be-classified application. Certainly, the label may alternatively be a label assigned in another manner, for example, assigned randomly, as long as each label is unique. No limitation is set thereto in the embodiments of the present disclosure.

In Substep 4062, the label of each to-be-classified application is transferred to a connected to-be-classified application.

In Substep 4063, a label is selected from the number of labels received by each to-be-classified application as a label it owns.

In Substep 4064, it is determined, in the new node diagram, whether a label owned by a to-be-classified application changes, or whether the current number of iteration is less than a preset maximum number of iteration.

In Substep 4065, the step of transferring the label of each to-be-classified application to a connected to-be-classified application is returned to if the label owned by the to-be-classified application changes or the current number of iteration is less than the preset maximum number of iteration.

In Substep 4066, to-be-classified applications owning the same label are grouped into the same classification diagram to obtain the one or more classification diagrams if the label owned by a to-be-classified application does not change or the current number of iteration is not less than the preset maximum number of iteration.

In the first iteration, a label may be randomly selected. Because a core node is connected to many other peripheral nodes, the probability that the label of the core node is randomly selected is relatively high. In subsequent iteration processes, the number of labels of the core node increases and gradually becomes stable.

When the labels become stable or the maximum number of iteration is reached, nodes having the same label belong to the same user group, and the label of the nodes may be used as an identification label of the applications.

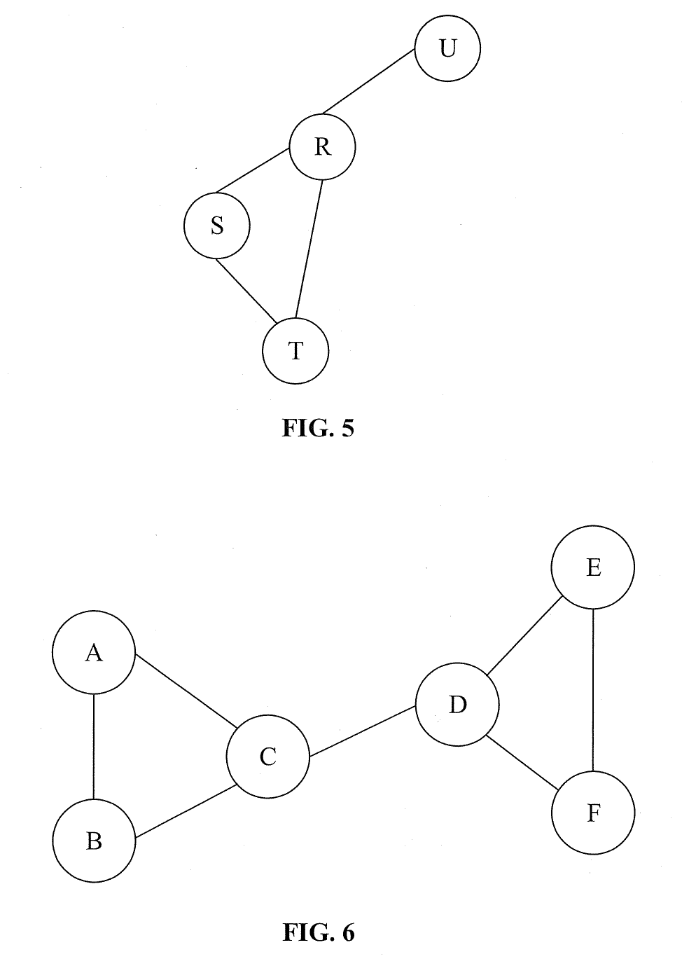

For example, FIG. 5 is a schematic diagram of a node diagram according to the present disclosure. Here, a name of a node is used as a label of the node. That is, labels of nodes R, S, T, and U are respectively R, S, T, and U. An iteration process of the labels is as follows:

| Iteration times | Node | Received label | Selected label |
|---|---|---|---|
| 1 | R | S, T, U | U |
| | S | R, T | R |
| | T | R, S | S |
| | U | R | R |
| 7 | R | R, R, S | R |
| | S | S, U | S |
| | T | R, U | R |
| | U | R | R |
| 3 | R | R, R, S | R |
| | S | R, R | R |
| | T | R, S | R |
| | U | R | R |

After the third iteration, labels owned by the applications are all R, and do not change any more. Therefore, the applications corresponding to the nodes R, S, T, and U belong to the same category, and may be grouped into the same classification diagram.

Certainly, in addition to the foregoing community division algorithm, other community division algorithms such as a Tommunity struTture in soTiR1 RnU SiologiTR1 networks (GN) algorithm or a LouvRin algorithm may be used. No limitation is set thereto in the embodiments of the present disclosure.

In Step 407, the one or more classification diagrams are merged; or the one or more classification diagrams are further divided. In these embodiments of the present disclosure, after a new classification diagram is obtained by using the foregoing method, the new classification diagram may be further processed. For example, the one or more classification diagrams are merged. Alternatively, the one or more classification diagrams are further divided.

In a specific implementation, if a plurality of classification diagrams need to be merged, the plurality of classification diagrams may be directly synthesized, and a hierarchical structure may be formed. For example, two original classification diagrams of FIG. 3A and of FIG. 3B can be synthesized as subcategories of a category C.

In some embodiments of the present disclosure, the step of further dividing the one or more classification diagrams may include the following substeps.

In Substep 4071, a betweenness of an edge between any two applications in the classification diagram is calculated.

In Substep 4072, an edge corresponding to a maximum betweenness value is deleted to obtain classification sub-diagrams.

In Substep 4073, it is determined whether the classification sub-diagrams are two connected graphs.

In Substep 4074, the step of calculating the betweenness of an edge between any two applications in the classification diagram is returned to if the classification sub-diagrams are not two connected graphs.

In Substep 4075, further division of the classification diagram is stopped if the classification sub-diagrams are two connected graphs.

In a specific implementation, the betweenness of the edge between the applications in the classification diagram can be calculated by using the following formula:

$$B ( e ) = \frac{p}{q}$$

wherein B(e) is a betweenness value corresponding to an edge e; q is the number of all shortest paths in the classification diagram; and p is the number of shortest paths including the edge e.

For example, FIG. 6 is a schematic diagram of a classification diagram according to the present disclosure, and based on the foregoing formula, betweenness values of the edges may be obtained as follows:
(1) AB: 1/30
(2) BC: 4/30
(3) AC: 4/30
(4) CD: 5/30
(5) DE: 4/30
(6) DF: 4/30

It can be learned through comparison that, the edge CD has a maximum betweenness value. Therefore, the edge CD is deleted. After the edge CD is deleted, the original classification diagram is divided into two connected graphs. that is, classification sub-diagrams ABC and DEF, thus achieving the results of dividing. Therefore, further division of the classification diagram may be stopped.

In the embodiments of the present disclosure, after a new application classification system is obtained, the new classification diagram may be further assessed depending on an actual need, and a merging or further division operation may be performed to ensure accuracy of a final classification.

It is noted that, for ease of description, the foregoing method embodiments are described as a series of action combinations. However, those skilled in the art should understand that the embodiments of the present disclosure are not limited to the described sequence of the actions, because some steps may be performed in another sequence or at the same time according to the embodiments of the present disclosure.

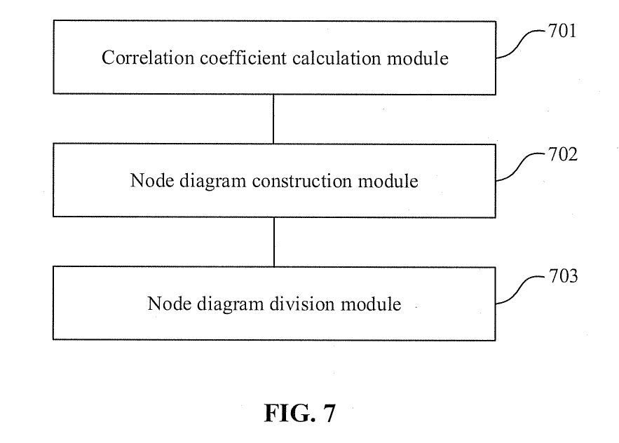

Referring to FIG. 7, a structural block diagram of some embodiments of an application classification apparatus according to the present disclosure is shown. The application classification apparatus may include the following modules: a correlation coefficient calculation module 701 configured to calculate a correlation coefficient between to-be-classified applications, wherein the to-be-classified applications are located in one or more known classification systems; a node diagram construction module 702 configured to construct a node diagram for the to-be-classified applications based on the correlation coefficient; and a node diagram division module 703 configured to divide the node diagram to obtain one or more classification diagrams.

In these embodiments of the present disclosure, the correlation coefficient calculation module 701 may include the following sub-modules: a shortest path determining sub-module 7011 configured to separately determine a shortest path between any two to-be-classified applications in the one or more known classification systems; and a correlation coefficient calculation sub-module 7012 configured to calculate a correlation coefficient between the any two to-be-classified applications by using the shortest path.

In these embodiments of the present disclosure, the correlation coefficient between the any two to-be-classified applications can be calculated by using the following formula:

$$w ( a , b ) = \frac{1}{n} * {\sum }_{n = 1}^{n} ( \frac{2}{shortest\_path ( a , b )} )$$

wherein w(a,b) is a correlation coefficient between to-be-classified applications a and b; n is the number of known classification systems; and shortest_path(a,b) is a shortest path between the to-be-classified applications a and b in a known classification system.

In these embodiments of the present disclosure, the node diagram construction module 702 may include the following sub-module: a node diagram construction sub-module 7021 configured to use the correlation coefficient as a weight of an edge between the to-be-classified applications and construct the node diagram for the to-be-classified applications based on the weight of the edge.

In these embodiments of the present disclosure, the node diagram division module 703 may include the following sub-modules: an edge weight determining sub-module 7031 configured to determine whether a weight of an edge in the node diagram is greater than a preset threshold; a first corresponding edge deletion sub-module 7032 configured to retain the corresponding edge when the weight of the edge is greater than the preset threshold or delete the corresponding edge to obtain a new node diagram when the weight of the edge is not greater than the preset threshold; and a node diagram division sub-module 7033 configured to divide the new node diagram to obtain the one or more classification diagrams.

In these embodiments of the present disclosure, the node diagram division sub-module 7033 may include the following units: a configuration unit 331 configured to assign a label to each to-be-classified application in the new node diagram; a transfer unit 332 configured to transfer the label of each to-be-classified application to a connected to-be-classified application; a selection unit 333 configured to select, from the number of labels received by each to-be-classified application, a label as a label owned by the to-be-classified application; a determining unit 334 configured to determine, in the new node diagram, whether a label owned by a to-be-classified application changes, or whether the current number of iteration is less than a preset maximum number of iteration; a return unit 335 configured to return to the step of transferring, by the transfer unit, the label of each to-be-classified application to a connected to-be-classified application when the label owned by the to-be-classified application changes or the current number of iteration is less than the preset maximum number of iteration; and a division unit 336 configured to group to-be-classified applications owning the same label into the same classification diagram to obtain the one or more classification diagrams when the label owned by the to-be-classified application does not change or the current number of iteration is greater than or equal to the preset maximum number of iteration.

In these embodiments of the present disclosure, the apparatus may further include the following modules: a classification diagram merging module 704 configured to merge the one or more classification diagrams; and a classification diagram division module 705 configured to further divide the one or more classification diagrams.

In these embodiments of the present disclosure, the classification diagram division module 705 may include the following sub-modules: an edge betweenness calculation sub-module 7051 configured to calculate a betweenness of an edge between applications in the classification diagram; a second corresponding edge deletion sub-module 7052 configured to delete an edge corresponding to a maximum betweenness value to obtain classification sub-diagrams; a connected graph determining sub-module 7053 configured to determine whether the classification sub-diagrams are two connected graphs; a return sub-module 7054 configured to return to the step of calculating the betweenness of an edge between the applications in the classification diagram when the classification sub-diagrams are not two connected graphs; and a stop sub-module 7055 configured to stop further division of the classification diagram when the classification sub-diagrams are two connected graphs.

In the embodiments of the present disclosure, the betweenness of the edge between the applications in the classification diagram is calculated by using the following formula:

$$B ( e ) = \frac{p}{q}$$

wherein B(e) is a betweenness value corresponding to an edge e; q is the number of all shortest paths in the classification diagram; and p is the number of shortest paths including the edge e.

The apparatus embodiments provide functionality that is basically similar to the functionality provided by the method embodiments, and therefore are described briefly. For related parts, refer to partial descriptions in the method embodiments.

The embodiments in this disclosure are all described in a progressive manner. Each embodiment focuses on a difference from other embodiments, and identical or similar parts in the embodiments may be obtained from each other.

Those skilled in the art should understand that the embodiments of the present disclosure may be provided as a method, an apparatus, or a computer program product. Therefore, the embodiments of the present disclosure may be implemented as a complete hardware embodiment, a complete software embodiment, or an embodiment combining software and hardware. Moreover, the embodiments of the present disclosure may be a computer program product implemented on one or more computer usable storage media (including, but not limited to, a magnetic disk memory, a compact disk read-only memory (CD-ROM), an optical memory, and the like) including computer-usable program code.

In a typical configuration, the computer device includes one or more processors (CPUs), an input/output interface, a network interface, and a memory. The memory may include a volatile memory, a random access memory (RAM) and/or a non-volatile memory or the like in a computer-readable medium, for example, a read-only memory (ROM) or a flash RAM. The memory is an example of the computer-readable medium. The computer-readable medium includes non-volatile and volatile media as well as movable and non-movable media, and can implement information storage by means of any method or technology. Information may be a computer-readable instruction, a data structure, and a module of a program or other data. A storage medium of a computer includes, but is not limited to, for example, a phase change memory (PRAM), a static random access memory (SRAM), a dynamic random access memory (DRAM), other types of RAMs, a ROM, an electrically erasable programmable read-only memory (EEPROM), a flash memory or other memory technologies, a CD-ROM, a digital versatile disc (DVD) or other optical storages, a cassette tape, a magnetic tape/magnetic disk storage or other magnetic storage devices, or any other non-transmission medium, and can be used to store information that can be accessed by a computing device. According to the definition in this disclosure, the computer-readable medium does not include computer-readable transitory media, such as a modulated data signal and a carrier.

The embodiments of present disclosure are described with reference to flowcharts and/or block diagrams with reference to the method, terminal device (system) and computer program product according to the embodiments of the present disclosure. It should be understood that a computer program instruction may be used to implement each process and/or block in the flowcharts and/or block diagrams and combinations of processes and/or blocks in the flowcharts and/or block diagrams. These computer program instructions may be provided for a computer, an embedded processor, or a processor of any other programmable data processing terminal device to generate a machine, so that the instructions executed by a computer or a processor of any other programmable data processing terminal device generate an apparatus for implementing a specified function in one or more procedures in the flowcharts and/or in one or more blocks in the block diagrams.

These computer program instructions may be stored in a computer-readable memory that can instruct the computer or any other programmable data processing terminal device to work in a particular manner, so that the instructions stored in the computer-readable memory generate an artifact that includes an instruction apparatus. The instruction apparatus implements a specified function in one or more processes in the flowcharts and/or in one or more blocks in the block diagrams.

These computer program instructions may be loaded onto a computer or another programmable data processing terminal device, so that a series of operations and steps are performed on the computer or the another programmable terminal device, thereby generating computer-implemented processing. Therefore, the instructions executed on the computer or the programmable terminal device provide steps for implementing a specified function in one or more processes in the flowcharts and/or in one or more blocks in the block diagrams.

Although embodiments of the present disclosure have been described, those skilled in the art can make extra changes and modifications to these embodiments once they learn the basic inventive concept. Therefore, the claims appended below are intended to be construed as to cover the embodiments and all changes and modifications falling within the scope of the embodiments of the present disclosure.

Finally, it is further noted that the relation terms herein such as first and second are merely used to distinguish one entity or operation from another entity or operation, but do not necessarily require or imply such an actual relation or sequence between the entities or operations. Moreover, the term “include,” “comprise,” or any other variant thereof is intended to cover a non-exclusive inclusion, so that a process, a method, an article, or a terminal device that includes a list of elements not only includes those elements but also includes other elements which are not expressly listed, or further includes elements inherent to such process, method, article, or terminal device. Unless otherwise specified, an element limited by “include a/an . . . ” does not exclude other same elements existing in the process, the method, the article, or the terminal device that includes the element.

Finally, it is noted that the above embodiments are merely provided for describing the technical solutions of the present disclosure, and not intended to limit the present disclosure. It is understood by those of ordinary skill in the art that although the present disclosure has been described in detail with reference to the foregoing embodiments, modifications can be made to the technical solutions described in the foregoing embodiments, or equivalent replacements can be made to some or all technical features in the technical solutions, while such modifications or replacements do not cause the essence of corresponding technical solutions to depart from the spirit and scope of the present invention.

An application classification method and an application classification apparatus provided in the present disclosure are described above in detail. Although the principles and implementation manners of the present disclosure are described by using specific examples in this disclosure, the foregoing descriptions of the embodiments are only intended to help understand the method and core idea of the method of the present disclosure. Meanwhile, persons of ordinary skill in the art may make variations to the specific implementations and application range according to the idea of the present disclosure. In conclusion, the content of the disclosure should not be construed as a limitation to the present application.

1. An application classification method, comprising:
determining a correlation coefficient between to-be-classified applications located in one or more known classification systems;
constructing a node diagram for the to-be-classified applications based on the correlation coefficient; and
dividing the node diagram to obtain one or more classification diagrams.

2. The method according to claim 1, wherein determining the correlation coefficient comprises:
determining a shortest path between any two to-be-classified applications in the one or more known classification systems; and
determining a correlation coefficient between the any two to-be-classified applications by using the shortest path.

3. The method according to claim 2, wherein the correlation coefficient between the any two to-be-classified applications is determined by using the following formula:
$$w ( a , b ) = \frac{1}{n} * {\sum }_{n = 1}^{n} ( \frac{2}{shortest\_path ( a , b )} )$$
wherein w(a,b) is a correlation coefficient between to-be-classified applications a and b; n is the number of known classification systems; and shortest_path(a,b) is a shortest path between to-be-classified applications a and b in a known classification system.

4. The method according to claim 2, wherein constructing the node diagram comprises:
using the correlation coefficient as a weight of an edge between the to-be-classified applications; and
constructing the node diagram for the to-be-classified applications based on the weight of the edge.

5. The method according to claim 4, wherein dividing the node diagram comprises:
determining whether a weight of an edge in the node diagram satisfies a preset threshold;
retaining the corresponding edge in response to the weight of the edge satisfying the preset threshold, and deleting the corresponding edge to obtain a new node diagram in response to the weight of the edge not satisfying the preset threshold; and
dividing the new node diagram to obtain the one or more classification diagrams.

6. The method according to claim 5, wherein dividing the new node diagram comprises:
assigning a label to each to-be-classified application in the new node diagram;
transferring the label of each to-be-classified application to a connected to-be-classified application;
selecting, from the number of labels received by each to-be-classified application; a label as a label owned by the to-be-classified application;
determining, in the new node diagram, whether a label owned by a to-be-classified application changes, or whether the current number of iteration is less than a preset maximum number of iteration;
performing again the transferring the label of each to-be-classified application to a connected to-be-classified application in response to the label owned by the to-be-classified application changing or the current number of iteration being less than the preset maximum number of iteration; and
grouping to-be-classified applications owning the same label into the same classification diagram to obtain the one or more classification diagrams in response to the label owned by the to-be-classified application not changing or the current number of iteration being not less than the preset maximum number of iteration.

7. The method according to claim 1, further comprising performing one of the following:
merging the one or more classification diagrams; or
further dividing the one or more classification diagrams.

8. The method according to claim 7, wherein further dividing the one or more classification diagrams comprises:
determining a betweenness of an edge between applications in the classification diagram;
deleting an edge corresponding to a maximum betweenness value to obtain classification sub-diagrams;
determining whether the classification sub-diagrams are two connected graphs;
performing again the determining a betweenness of an edge between applications in the classification diagram in response to the classification sub-diagrams being not two connected graphs; and
stopping further division of the classification diagram in response to the classification sub-diagrams being two connected graphs.

9. The method according to claim 8, wherein the betweenness of the edge between the applications in the classification diagram is determining by using the following formula:
$$B ( e ) = \frac{p}{q}$$
wherein B(e) is a betweenness value corresponding to an edge e; q is the number of all shortest paths in the classification diagram; and p is the number of shortest paths comprising the edge e.

10. An application classification apparatus, comprising:
one or more memories configured to store executable program code; and
one or more processors configured to read the executable program code stored in the one or more memories to cause the application classification apparatus to perform:
determining a correlation coefficient between to-be-classified applications located in one or more known classification systems;
constructing a node diagram for the to-be-classified applications based on the correlation coefficient; and
dividing the node diagram to obtain one or more classification diagrams.

11. The apparatus according to claim 10, wherein the one or more processors are configured to read the executable program code to cause the application classification apparatus to further perform:
determining a shortest path between any two to-be-classified applications in the one or more known classification systems; and
determining a correlation coefficient between the any two to-be-classified applications by using the shortest path.

12. The apparatus according to claim 11, wherein the correlation coefficient between the any two to-be-classified applications is determined by using the following formula:
$$w ( a , b ) = \frac{1}{n} * {\sum }_{n = 1}^{n} ( \frac{2}{shortest\_path ( a , b )} )$$
wherein w(a,b) is a correlation coefficient between to-be-classified applications a and b; n is the number of known classification systems; and shortest_path(a,b) is a shortest path between to-be-classified applications a and h in a known classification system.

13. The apparatus according to claim 11, wherein the one or more processors are configured to read the executable program code to cause the application classification apparatus to further perform:
using the correlation coefficient as a weight of an edge between the to-be-classified applications; and
constructing the node diagram for the to-be-classified applications based on the weight of the edge.

14. The apparatus according to claim 13, wherein the one or more processors are configured to read the executable program code to cause the application classification apparatus to further perform:
determining whether a weight of an edge in the node diagram satisfies a preset threshold;
retaining the corresponding edge when the weight of the edge satisfies the preset threshold and delete the corresponding edge to obtain a new node diagram when the weight of the edge does not satisfy the preset threshold; and
dividing the new node diagram to obtain the one or more classification diagrams.

15. The apparatus according to claim 14, wherein the one or more processors are configured to read the executable program code to cause the application classification apparatus to further perform:
assigning a label to each to-be-classified application in the new node diagram;
transferring the label of each to-be-classified application to a connected to-be-classified application;
selecting, from the number of labels received by each to-be-classified application, a label as a label owned by the to-be-classified application;
determining, in the new node diagram, whether a label owned by a to-be-classified application changes, or whether the current number of iteration is less than a preset maximum number of iteration;
performing again the transferring, by the transfer unit, the label of each to-be-classified application to a connected to-be-classified application when the label owned by the to-be-classified application changes or the current number of iteration is less than the preset maximum number of iteration; and
grouping to-be-classified applications owning the same label into the same classification diagram to obtain the one or more classification diagrams when the label owned by the to-be-classified application does not change or the current number of iteration is greater than or equal to the preset maximum number of iteration.

16. The apparatus according to claim 10, wherein the one or more processors are configured to read the executable program code to cause the application classification apparatus to further perform:
merging the one or more classification diagrams; and
further dividing the one or more classification diagrams.

17. The apparatus according to claim 16, wherein the one or more processors are configured to read the executable program code to cause the application classification apparatus to further perform:
determining a betweenness of an edge between applications in the classification diagram;
deleting an edge corresponding to a maximum betweenness value to obtain classification sub-diagrams;
determining whether the classification sub-diagrams are two connected graphs;
performing again the determining a betweenness of an edge between applications in the classification diagram when the classification sub-diagrams are not two connected graphs; and
stopping further division of the classification diagram when the classification sub-diagrams are two connected graphs.

18. The apparatus according to claim 17, wherein the betweenness of the edge between the applications in the classification diagram is determined by using the following formula:
$$B ( e ) = \frac{p}{q}$$
wherein B(e) is a betweenness value corresponding to an edge e; q is the number of all shortest paths in the classification diagram; and p is the number of shortest paths comprising the edge e.

19. A non-transitory computer-readable storage medium storing a set of instructions that is executable by one or more processors of an electronic device to cause the electronic device to perform a method comprising:
determining a correlation coefficient between to-be-classified applications located in one or more known classification systems;
constructing a node diagram for the to-be-classified applications based on the correlation coefficient; and
dividing the node diagram to obtain one or more classification diagrams.

20-27. (canceled)
